(19) United States
(12) Patent Application Publication
(10) Pub. No.: US 2007/0101378 A1
(43) Pub. Date: May 3, 2007

(54) Redundant transmission of programmes

(75) Inventor: Lambert Hubert Augustin Jacobs, Bilzen (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/554,846

(22) PCT Filed: Apr. 29, 2004
(86) PCT No.: PCT/IB04/50545

§ 371 Date: Oct. 28, 2005

(30) Foreign Application Priority Data
May 2, 2003 (EP) 03101230.5

(51) Int. Cl. H04N 7/173

(52) U.S. Cl. 725/90; 725/118; 725/93; 725/94; 725/115

(57) ABSTRACT

A compression system 110 compresses a programme into a first and second sequence of corresponding blocks. A transmission system 120 transmits blocks of the second sequence according to a predetermined real-time delivery schedule. The transmission system transmits the blocks of the first sequence earlier than corresponding blocks of the second sequence. A receiver 135 receives blocks of the second sequence and the first sequence. A buffer 140 temporarily stores blocks of the first sequence that correspond to blocks of the second sequence for which the delivery schedule has not yet expired. A controller 160 directs to the output 155 for each time interval of the delivery schedule a representation of a block of the second sequence if such a block was received successfully for the time interval or, otherwise, a representation of a corresponding block stored in the buffer.

### FIELD OF THE INVENTION

The invention relates to a delivery system for streamed delivery of a programme that includes a sequence of content parts.

### BACKGROUND OF THE INVENTION

Streamed delivery of digital content is quickly becoming a main form of delivery of programmes, in particular audio and/or video (A/V) programmes. The delivery system may, for example, be a digital broadcast system based on satellite broadcasting, digital terrestrial broadcasting or digital cable broadcasting. Such digital broadcast systems and receivers have, for example, been defined in the form of the European DVB/MHP (Multi-media Home Platform) and the US DASE platform.

Also Internet is quickly becoming a main delivery system for streamed delivery of audio/video programmes. Internet supports many media, including several wireless media. In particular, streaming to mobile devices is gaining attention.

With the increased availability of high-capacity storage systems, such as hard disks, CD, DVD, Blue-Ray, flash memory, MRAM, FRAM, etc, at low cost also in-home delivery systems are getting available. For example, within the Universal Plug and Play (UPnP) architecture a Media Server has been described. The current publicly available versions of those standards are:
Universal Plug and Play (UPnP) Version 1.0 of 8 Jun. 2000
UPnP Audio/Video(A/V) Architecture Version 0.83 for UPnP Version 1.0. Status: Preliminary Design (TPD), date: Jun. 12, 2002, not yet finished;
MediaServer:1 Device Template Version 1.01, for Universal Plug and Play Version 1.0, Status: Standardized DCP, date: Jun. 25, 2002.

A Media Server in a UPnP compliant network can contain various types of content that other devices in the network would like to access (e.g. music, videos, still images, etc). The user can select an object stored on the Media Server and cause it to be “played” on an appropriate rendering device (e.g. an audio player for music objects, a TV for video content, an Electronic Picture Frame for still-images, etc). The UPnP A/V Architecture allows devices to support different types of formats for the entertainment content (such as MPEG2, MPEG4, DIVX, JPEG, JPEG2000, MP3, ATRAC, Windows Media Architecture (WMA), bitmaps (BMP), NTSC, PAL, ATSC, etc.) and multiple types of transfer protocols (such as IEC-61883/IEEE-1394, HTTP GET, RTP, HTTP PUT/POST, TCP/IP, etc.). Example instances of a Media Server include traditional devices such as VCRs, CD Players, DVD Players, audio-tape players, still-image cameras, camcorders, radios, TV Tuners, and set-top boxes. Additional examples of a Media Server also include new digital devices such as MP3 servers, Personal Video Recorders (PVRs), and Home Media Servers such as the PC.

All of the described delivery systems support streamed delivery of a programme (also referred to as title). The programme may, for example, include an audio stream, like music or commentary in the main language. Additional audio streams may also be present in the programme, for example for additional commentaries in different languages. The programme may also include a video stream (or even more than one, e.g. for multi-camera programmes). Typically, the programme is compressed, e.g. in MPEG2, MPEG4 or DIVX format. Streamed delivery means that successive content parts of the (compressed) programme are transmitted as a continuous stream of blocks usually with limited jittering on the delivery. The blocks are supplied at a rate that enables real-time decompression and rendering by a rendering device that is included in or attached to a receiver. The receiver typically has a small buffer for storing a few blocks to compensate for jitter in the delivery. If the delivery is interrupted (one or more blocks are not received or contain non-correctable errors) the rendering will also be interrupted (or at least degraded if the interruption is very short). Since the streaming is intended for real-time delivery to a rendering device there is no time (nor any provision in the networking protocols that are used) to correct a loss of blocks in the transmission.

Network congestion is a main cause for a temporary loss of packets. In addition, many of the delivery systems are based on or allow wireless delivery. This increases the chances of a temporary loss of streamed blocks. In particular mobile rendering devices, such as an in-car digital radio/video, are subject to a loss, for example if the reception is temporarily interrupted by buildings, tunnels, etc. The same holds for hand-held devices, such as mobile phones and PDAs (Personal digital Assistants) with built-in mobile reception capabilities. Also in-home wireless delivery systems are expected to become important, for example based on the IEEE 802.11 family of protocols. Those systems are also very susceptible to temporary interruption of the delivery, e.g. activation of a microwave may cause a temporary interruption that may be recovered by switching to a different reception channel or mode Many of the described interruptions/disturbances can not be compensated for by the currently used reception buffer that is mainly used for dealing with reception jittering but not with reception interruption.

### SUMMARY OF THE INVENTION

It is an object of the invention to provide a delivery system for streamed delivery of programmes that is better capable of dealing with one or more interruption(s) in the reception.

To meet the object of the invention, a delivery system for streamed delivery of a programme including a sequence of content parts includes:

a compression system for compressing the programme into a first sequence of blocks and into a second sequence of blocks; a correspondence between blocks of the first and second sequence being established by blocks in the first sequence and the second sequence that relate a same content part in the programme being identifiable;

a transmission system for delivery of blocks of the second sequence to a reception system according to respective time intervals of a predetermined real-time delivery schedule and for delivery of the first sequence of blocks to the reception system, where blocks of the first sequence are being transmitted earlier than corresponding blocks of the second sequence; and

a reception system, including: a receiver for streamed reception of the second sequence of blocks and for reception of the first sequence of blocks; a buffer for temporarily storing blocks of the first sequence of blocks that correspond to blocks of the second sequence for which the delivery schedule has not yet expired; an output for supplying content parts of the programme; and a controller operative to direct to the output for each time interval of the delivery schedule: a representation of a block of the second sequence if such a block was received successfully for the time interval, or a representation of a corresponding block stored in the buffer if the block of the second sequence was not received successfully for the time interval.

According to the invention, a programme is delivered twice to a reception system in the form of a first and second sequence of blocks. During normal operation, the reception system provides the second sequence real-time to a destination device, such as a rendering device. The second sequence is transmitted using stream transmission. The transmission of both sequences is time-shifted with respect to each other. The first sequence is transmitted at least one block ahead. The first sequence acts as a fall-back. If the streamed reception of the second sequence is not successful for one or more blocks (e.g. one or more blocks of the second sequence are and will not be received in real-time or are corrupt), the reception system supplies at its output a representation of blocks of the first sequence. To this end, one or more blocks of the first sequence are temporarily buffered in the reception system, either in compressed or decompressed form.

In a preferred embodiment as described in the dependent claim 2, the first sequence has a higher level of compression (i.e. lower bit-rate). In this way, with a fixed size buffer a larger period of interruption (or complete loss) of the reception of the second sequence can be bridged. Alternatively, a smaller buffer can be used than if a full-quality stream was buffered. Typically, the prior art systems are not able to render any signal during an interruption of the reception. In the system according to the invention, during such an interruption rendering of the programme continues, albeit at a lower quality.

According to the measure of the dependent claim 3, the first and second sequences are transmitted using distinct transmission channels. In this way the chance is reduced that both sequences can not be received. If reception of the second sequence is interrupted (e.g. certain blocks of the second stream are missing or corrupt) the reception system provides the corresponding blocks from the buffer (i.e. blocks of the first sequence). If the reception of the first sequence is not interrupted, the buffer can continuously be re-filled, allowing overcoming a very long (or even total) interruption of reception of the second sequence.

Preferably, the first sequence of blocks is delivered as a stream (e.g. broadcast) as described in the dependent claim 4. Any suitable form of streaming, such as satellite or digital terrestrial broadcasting, may be used. If both sequences are streamed, the sequences may be multiplexed in the same transport stream as described in the dependent claim 5, simplifying reception since only one transport stream needs to be identified by a user for reception and reduces costs (only one tuner is required).

The first sequence of blocks may be downloaded on demand, as described in the dependent claim 7. This provides for a flexible system, wherein the receiving system determines whether or not redundancy is required. Downloading of a redundant sequence may be charged to the downloading system (or its user).

As described in the dependent claim 8, before starting the transmission of the second sequence (or in a starting phase of the transmission), first the buffer is filled with blocks of the first sequence to be able to fall-back to rendering blocks of the first sequence. It is possible to only partially fill the buffer so that at least a minimal fall-back position is achieved already at the start of the programme. The buffer may then gradually be filled further by using some spare transmission capacity.

As described in the dependent claim 9, the reception system includes a decompressor for decompressing blocks of the first and second sequence of blocks; the controller being operative to cause decompression of a block of the second sequence substantially in response to receipt of the block, and to cause decompression of a block of the first sequence substantially synchronous to decompression of a corresponding block of the second sequence. So, the first sequence is decompressed synchronous to the second sequence, so that a ‘seamless’ switch from rendering the second sequence to the first sequence can be achieved, for example at video frame level. With many decompressors used in consumer electronics products a noticeable delay may occur if a switch occurs to a not yet decompressed stream. For example, in an MPEG2 encoded stream first an I-frame must be located and decompressed before frames depending on the I-frame can be decompressed. In worst case this may involve decoding an entire Group of Picture (GOP) of typically 15 frames before the desired frame is available. Most decompressors are not designed to decode a GOP in a time interval available for rendering one frame (i.e. 15 times as fast decoding than rendering). By decompressing the first sequence always (synchronous to the second sequence), a decoded frame is always available (even if not used).

These and other aspects of the invention are apparent from and will be elucidated with reference to the embodiments described hereinafter.

### BRIEF DESCRIPTION OF THE DRAWINGS

In the drawings:

FIG. 1 shows a block diagram of the system according to the invention;

FIG. 2 shows a block diagram of a digital broadcast system including the system according to the invention;

FIG. 3 shows a block diagram of a digital broadcast reception system;

FIG. 4 shows a block diagram of an in-home delivery system;

FIG. 5 shows an MPEG2 sequence of frames; and

FIGS. 6 to 8 illustrate ways of filling up the buffer according to the invention.

### DETAILED DESCRIPTION OF THE PREFERRED EMBODIMENT

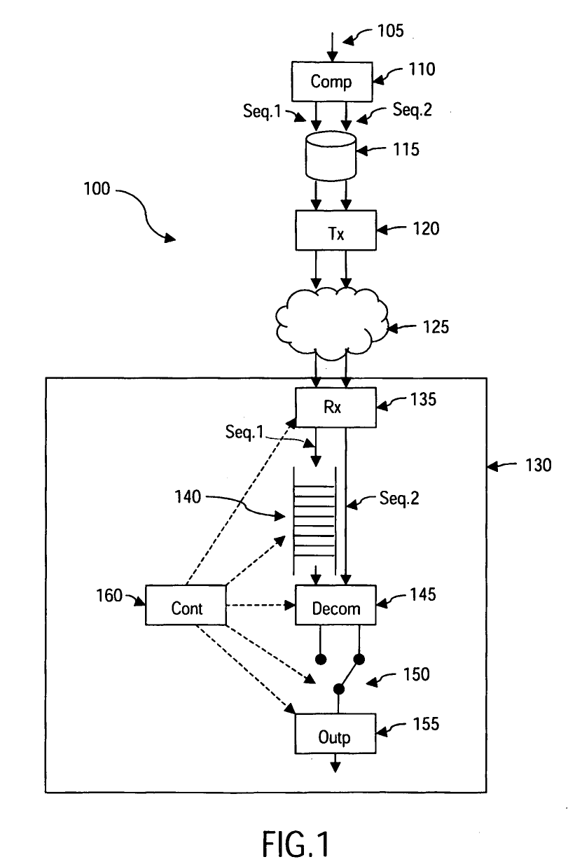

FIG. 1 shows a block diagram of a preferred delivery system 100 according to the invention. One or more programmes are delivered in a digital form to a receiver. The programme may in principle be any content that can be supplied and rendered as a digital stream. Typically, the programme includes audio and/or video. The programme is delivered in a redundant form. To be able to overcome a possible significant gap in correct receipt of the main delivery of the programme, the programme is delivered twice with a significant time shift between both deliveries. Preferably, the time shift is at least 20 seconds (at the start of the transmission the time shift may be less or non-existing as will be described in more detail below). The first delivery acts as a fall-back. At least the main delivery is in the form of streaming. Streaming protocols are well-known and will not be described here further. For streamed digital delivery, it is normal that the stream is compressed, for example using MPEG2 compression. To this end, the system 100 includes a compressor 110 for compressing a programme 105 into the main sequence of blocks, referred to as Seq.2. In principle it is possible to provide the programme in uncompressed form but since this increases the load on the transmission system that will not normally be the case. Preferably, the fall-back delivery Seq.1 is supplied in a lower bit-rate encoding than the main delivery Seq.2. In this way, storage requirements are reduced in the receiver and the load on the network is reduced. To this end, the same programme is encoded twice by the compressor 110, giving the main sequence of blocks Seq.2 and the fall-back sequence Seq.1. It will be appreciated that the same principle can be repeated: a third sequence (preferably at an even lower bit-rate and still earlier) provides a fall-back for the first sequence, etc.

In principle, the compressor 110 may operate in real-time, i.e. a block supplied from the compressor 110 is ‘immediately’ transmitted to the receiving system 130. It is then preferred that the compressor has the capacity to real-time encode two programmes. Alternatively, two compressors may be used, each assigned to generate one of the sequences. Usually, compression will take place off-line (i.e. non real-time). The compressed sequences are then stored in a storage device 115, such as a hard disk, before being transmitted.

The compressed sequences are transmitted using a transmitter 120. In the figure, one transmitter 120 and one network 125 is shown. In principle, the sequences may be transmitted using distinct transmitters and/or distinct networks. The receiving system includes a receiver 135. Again, if so desired distinct receivers may be used for the respective sequences. The remainder will focus on a system with one transmitter, one network and one receiving system. In general, the system may include several receiving systems, e.g. one or more per house, one per car, etc. Sequence 1 is supplied from the receiver 135 to a buffer 140. The buffer may be a FIFO, for example in the form of a cyclic buffer. It is capable of storing blocks of Seq.1. Its capacity can be restricted to the amount of data transmitted for Seq.1 during a time interval that Seq.1 is ahead of Seq.2. So, if Seq.1 is five minutes ahead of Seq.2, then five minutes of data of Seq.1 must be buffered. A controller 160 selects from which of the sequences blocks are sent to the output 155. To this end, the controller may control a switch 150. It will also be appreciated that the selection may be performed in software by simply selecting the right block from a memory and directing it to the output. Normally data is supplied from Seq.2 for further processing. If no (correct) block of Seq.2 is available at the moment it should be output, instead a corresponding block of Seq.1 is output. The data may be supplied to an external device, such as a rendering device or storage device. Such functionality may also be embedded in the receiving system 130. Blocks supplied to the output may optionally be decompressed by a decompressor 145 before being supplied to the output. Preferably, the decompressor is located sequentially after the buffer 140, so that blocks of Seq.1 are stored in a compressed form, reducing the buffering requirements. As will be described below in more detail some parts of the data of Seq.1 may need to be decompressed beforehand to enable ‘seamless’ switching from Seq.2 to Seq.1 if no (correct) data of Seq.2 is available. In addition to controlling the selection of blocks to be output, the controller 160 may also control functions embedded in hardware, e.g. the receiver 135 and decompressor 145, and provide additional software functionality.

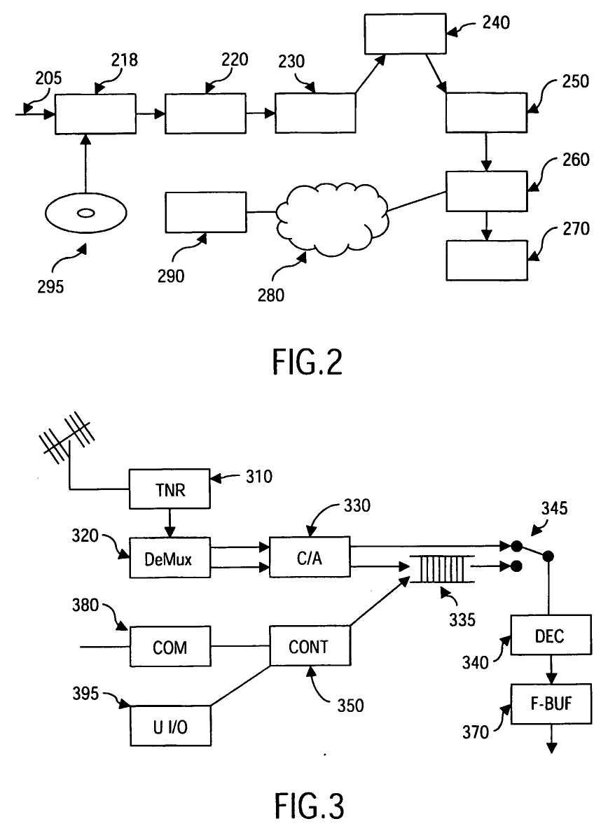

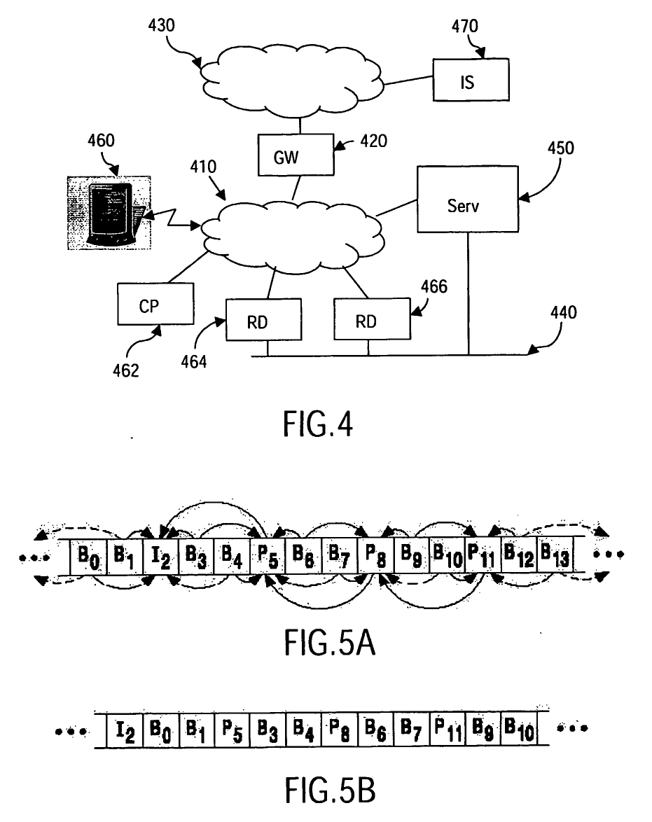

FIGS. 2 and 3 provide more details of a digital television system in which the invention can be used. As an example, a system is described wherein the audio/video (A/V) signals (programme) are distributed digitally using MPEG-2 compression to compress the A/V signals. The system includes an MPEG-2 compressor 210, usually located in a broadcast centre. The compressor receives a digital signal stream (typically a stream of digitized analog or digital video signals). The original signals may be supplied via a link 205 by a service provider. It is also possible that the programme is loaded from a storage medium 295, such as a hard disk, CD-ROM, DVD, or solid state memory, which stores A/V data. Usually, the title is received in a compressed form, for example using MPEG-2 coding. For transmission, the title may be changed, for example some parts may be removed, for example to reduce the length, and some other parts, like commercials, may be added. Consequently, the title will usually be re-coded by the compressor/coder 210. The compressor 210 is connected to a multiplexer 220, with an optional scrambling function. The scrambler scrambles the digital signals of a data stream by encrypting them under control of a content key. The multiplexer 220 may receive in addition to one or more scrambled or non-scrambled data stream also further digital signals. The multiplexer 220 assembles all the signal and streams into a transport stream and supplies the compressed and multiplexed signals to a transmitter 230 of the broadcast centre. The scrambling and multiplexing functions may be performed in separate units, and if desired at different locations. The multiplexed transport stream may be supplied from the scrambler/multiplexer 220 to the transmitter 230 using any suitable form of linkage, including telecommunication links. The transmitter 230 transmits electromagnetic signals via an uplink towards a satellite transponder 240, where they are electronically processed and broadcast via a downlink to an earth-based satellite receiver 250, conventionally in the form of a dish of the end user. In the figure, the satellite receiver 250 is connected to an integrated receiving system 260. The operation of the receiving system 260 is described in more detail below with reference to FIG. 3. The receiving system selects the desired signal and presents it in a suitable form to a rendering device, such as a television 270. The signal may also be recorded using a tape, optical disc or hard disk recorder or other suitable recorder. The signal may be supplied to the rendering/recording device in an analog or digital form using well-known distribution systems such as CATV cable, or IEEE 1394. For digital distribution only partial decoding of the transport stream is required, where the de-multiplexed signals are supplied in the MPEG-2 coding using partial transport streams. It will be understood that the main distribution of the A/V signals does not need to take place via satellite. Instead other delivery systems (i.e. the physical medium by which one or more multiplexes are transmitted) may be used, such as terrestrial broadcast, cable transmission, combined satellite/cable, or mobile telecommunication based broadcasting. The party that distributes the program via the delivery system is sometimes referred as the network provider. It will also be understood that the receiver/decoder 260 may be integrated into the rendering or recording device. In particular the reception/rendering system 260 may be part of a mobile system, such as a radio/TV system in a car, mobile phone or mobile PDA.

A typical system operates as a multi-channel system, implying that the multiplexer 220 can handle A/V information received from a number of (parallel) sources and interacts with the transmitter 230 to broadcast the information along a corresponding number of channels or multiplexed into separate transport streams. In addition to A/V signals, messages or applications or any other sort of digital data may be introduced in some or all of these services/channels interlaced with the transmitted digital audio and video information. As such a transport stream includes one or more services, each with one or more service components. A service component is a mono-media element. Examples of service components are a video elementary stream, an audio elementary stream, a Java application (Xlet), or other data type. A transport stream is formed by time-multiplexing one or more elementary streams and/or data. In a preferred embodiment, both sequences (Seq.1 and Seq.2) are multiplexed in the same transport stream time-shifted with respect to each other, where Seq.1 is broadcast (partly) ahead of Seq.2.

In the broadcast system of FIG. 2 at least the main programme delivery, being Seq.2, is broadcast. Preferably the system also supports bidirectional communication, for example to facilitate interactive applications, such as interactive video, e-commerce and so on, and to enable the receiver to obtain additional information/functionality from a server 290. Shown is the use of a wide area network 280, preferably the open Internet, where the added functionality and interactivity is provided by a web site on a web server 290. In an embodiment according to the invention, the first sequence can be downloaded on demand from the server 290. To enable this, the server 290 also has a connection to the coder/transcoder/re-encoder 210. This may be a direct link but may also be via the Internet. In this way, the server receives the first sequence Seq.1 and stores this for on-demand downloading to the receiver 260. The server may also receive the first sequence after it has been scrambled by the scrambler function 220. The server may charge for downloading of the Seq.1. The charging may be based on subscription, or actual usage. Using scrambling reduces the chances of unpaid use of the system, for example by distributing a downloaded sequence to more receivers than paid for.

It will be understood that the communication functionality of Internet or similar communication system may be provided in any suitable form. For example, the receiver may communicate via a cable network or satellite connection, directly using Internet protocols. Alternatively, the receiver may have a telephone-based dial-in connection to an access provider that provides access to the Internet. The receiver may, but need not use Internet protocols. If the server 290 does use Internet protocols, protocol conversion may take place, for example using a gateway.

Although the system of FIG. 2 is described for a digital broadcast system, in principle the invention can also be applied for non-broadcast transmissions. For example, the same concepts can be applied easily where a programme is supplied to individual receivers, for instance on a pay-per-view basis. The transmission may then take place via a typical broadcast system (but directly addressed) or via other suitable systems, such as a high-bandwidth Internet connection.

FIG. 3 shows more details of a typical broadcast receiver. The broadcast receiver, preferably, complies with a defined platform like the European MHP (Multi-media Home Platform) or the US DASE platform. The broadcast receiver includes a tuner 310. The tuner 310 extracts a separate tunable Radio Frequency (RF) band usually resulting in an MPEG2 transport stream. Various data signals are separated from the constant carrier signal by the de-multiplexer 320 (De-MUX). The results often are audio, video and data outputs. If as described above for a preferred embodiment, both sequences are multiplexed in the same transport stream, both sequences will be separately supplied by the demultiplexer 320. If a sequence includes both an audio and video elementary stream, the demultiplexer may supply four elementary streams in parallel. The streams may be fed through a Conditional Access subsystem 330, which determines access grants and may decrypt the data.

The main sequence (seq.2) is typically fed directly to a decoder 340, which converts the stream into signals appropriate for the video and audio rendering or storage devices. This may involve full or partial MPEG2 decoding. Sequence 1 is first temporarily buffered in a buffer 335. Only when the time of rendering of this stream has arrived, is the data that is required at that moment for rendering fed through the decoder 340. A selector 345 is used to select which of the stream should be provided to the output Normally, this is data of the main sequence Seq.2. However, if no data is available of this sequence, data of Seq.1 is used. It will be appreciated that the first sequence Seq.1 may also be broadcast in a different transport stream then used for sequence 2. In this case, a ‘double’ tuner may be used in order to simultaneously receive both transport streams. Similarly, two demultiplexers may be used, or a demultiplexer capable of parallel demultiplexing of two transport streams. In an analogous way, also two descramblers may be required.

FIG. 3 also shows an alternative arrangement for supplying the first sequence. In this embodiment, the receiver also includes a communication interface 380 for bi-directional communication to the server 290. Any suitable communications hardware/software may be used for this, including conventional modems for standard telecommunication lines (e.g. POTS or ISDN) or broadband modems (e.g. ADSL). The bi-directional communication channel facilitates downloading Seq.1 from the server 290 of FIG. 2. Downloaded blocks are temporarily stored in the buffer 335 for supply to the decoder as described above for the case where Seq.1 was broadcast. Preferably, Internet protocols are used for the bi-directional communication, for example those defined in the MHP “Internet Access Profile”. Output of the decoder can be supplied to a rendering device or storage device for subsequent rendering. Typically, the output is first stored in a buffer, such as a video frame buffer 370 for subsequent supply to the rendering/storage device. For certain applications, the receiver may provide partially encoded output streams, bypassing the decoder 340. The rendering device may then include the decoder function or the encoded stream may at a later stage be re-supplied to the receiver for further decoding. The encoded data stream may also be recorded in a storage system for rendering at a later moment. A user interface 395 of the receiver enables the receiver to interact with the user. The user interface 395 may include any suitable user input means, such as an Infrared receiver for receiving signals from an IR remote control, a keyboard, or a microphone for voice control. For output, also any suitable form may be used, such as using a small LCD display or using the display of a television, or even audible feedback.

It will be appreciated that the various functions, such as the tuner function 310, the de-multiplexer function 320, the optional descrambler/decryptor function 330, and the decoder function 340 may be performed using dedicated hardware. Some functions or part of the functions may also be performed by a programmable processing function, for instance using a digital signal processor (DSP) loaded with a suitable program, or media-processors (e.g. TriMedia) or programmable logic (e.g. FPGAs). The various functions within the receiving system are operated under control of the controller 350, which typically includes an embedded microprocessor or microcontroller. The controller is loaded with a program for performing the control function. Typically, the program is loaded from a non-volatile solid state memory, such as ROM or flash.

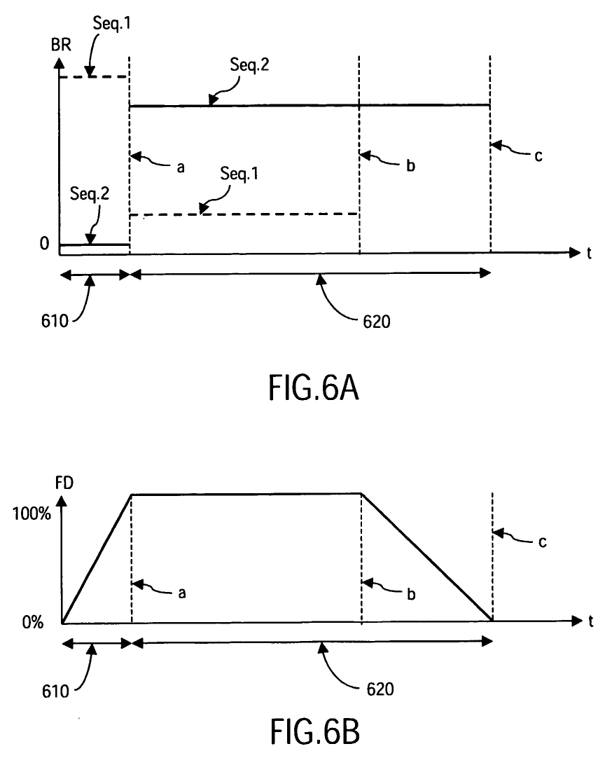

FIG. 4 shows a block diagram of a further exemplary system targeted towards in-home delivery of the programme. In the figure a hierarchy of networks is shows. In this example, the main network 410 is a home network that may be based on the UPnP architecture, but in principle any suitable technology may be used. The description of FIG. 4 focuses on a UPnP network. UPnP is based on IP technology and supports many network media and higher level protocols. The media may be wired, e.g. from the Ethernet family of media, or wireless, such as based on IEEE 802.11 family of media. A gateway/router 420 may be used to couple the home network 410 to an external network 430, such as the open Internet. The external network may also include devices, such as device 470 that may be an Internet server. A third network 440 may exist for the transfer of, in particular, streaming A/V data. Such a network may be based on a technology, like IEEE 1394 (or USB), that supports isochronous communication. The streaming technology may be wired or wireless. The system includes a plurality of devices that can communicate via the network. A major role is given to the server device 450 that may include a content directory service (hereinafter “CDS”) as defined for UNnP. For simplicity only one device with a CDS is shown. The other devices, such as device 460, 462, 464,466 are able to communicate with each other and/or with the server 450. The devices may have the same or different roles. The devices 460 and 462 are able to control other devices in the system; in UPnP such devices are called control points. A device, like the server 450, may be able to supply content to sinks of such content, like the rendering devices 464 and 466. These various roles may be freely combined. For example, the control point 460 may also be able to render a movie stored in the server 450. Any of the devices may be implemented using conventional hardware and software. For example, the server 450 may be implemented on a personal computer platform, if so desired, with reliable background storage, such as a RAID system or rewritable DVD, for storing the CDS. The server 450 may also be implemented on a Consumer Electronics (CE) device, such as a receiver (e.g. set top box) with integrated hard disk The rendering devices may be CE devices, such as a TV, audio amplifier, etc. The UI devices may also be CE devices, such as TVs, but may also be hand-held devices such as PDAs, or advanced programmable remote controls, or game consoles (like the XBOX) etc. Each of the devices in the system includes the necessary hardware and/or software for communicating with the other devices through the network. The rendering device may have functionality as described for the receiving system 130 of FIG. 1. The system of FIG. 4 shows various ways of supplying the sequences to from the server to the rendering device. For example, both sequences may be streamed via network 440. Alternatively, the two sequences may be streamed via the respective network 410 and 440, for example sequence 2 via the network 440 that is optimized for A/V streaming and sequence 1 via network 410. It is also possible to supply sequence 1 in a non-streaming way, preferably via network 410.

As described above, the programme is preferably compressed twice to the respective sequences of blocks Seq.1 and Seq.2. Preferably, the fall-back sequence Seq.1 has a higher compression ratio than the main sequence Seq.2. In principle different compression techniques may be used for the respective sequences. For the invention it is required that the receiver has knowledge of the correspondence between blocks of the sequences. For easy block-matching, extra information might be embedded in the stream (such as an incremental picture number, embedded as user-data in the MPEG2-video-stream) or might be derived from relations between the time-stamps (PCR, PTS, DTS) of the 2 streams. If data of sequence 2 is not available in the receiver (not received at all, or in corrupt, non-recoverable form), the controller should supply corresponding data of sequence 1, if that is correct and available. Using the same compression technique (and settings like GOP-size etc) for both sequences normally results in same structured sequences, only with differing number of bits per block. If differing techniques are used, the correspondence may be less obvious. It will be appreciated that a correspondence can always be established since both sequences are linked by being compressed from and decompressed to the same programme. If this correspondence is difficult to establish in real-time by the receiving system, it is possible to generate a file in the transmitting system, using information from the compressor that describes the correspondence between both sequences. This linking file can be transmitted to the receiving system, for example embedded in the steam, and used by the controller 160 of FIG. 1. Normally, the uncompressed programme consists of a temporal sequence of blocks that are rendered together. For example, for video such a programme block may be a video field, video frame or even a group of frames (as will be described in more detail below for MPEG2). For audio it may be one audio sample, but preferably a number of, for example 12 or 36, audio samples are grouped in an audio frame and coded as a unit. The compression may use information of more than one temporal programme block for one block of the compressed sequence of blocks. This may have the effect that the receiving system in order to generate one block of the uncompressed programme for rendering of the block may need to operate on several of the blocks of the transmitted sequence. Consequently, in order to obtain a seamless switch from sequence 2 to sequence 1 several blocks of sequence 1 may need to be buffered in a decompressed form.

In a preferred embodiment, first it is checked if a block (or a sequence of blocks) of the second sequence are received correctly, for example by checking a Cyclic Redundancy Check (CRC). If correct, the block (or blocks) is decoded. If not, the replacement block of sequence 1 is sent to the decoder. Preferably, corresponding blocks of both sequences have a corresponding block number to enable quick identification of the replacement block.

As described above, for audio a block may be one audio sample. However, it is preferred to group a number of successive audio samples (e.g. 12 or 36) as is typically the case for MPEG1-layer 1/2/3 and code each frame independently. The sample rate thus determines the duration of a frame. The receiver can simply assign a sequence number (or similarly a play-back time interval, being the sequence number times the frame duration) to each of the coded frames received for sequence 1 and 2. It can use this information to select the replacement frame of sequence 1 if no correct frame of sequence 2 is available.

The above described mechanisms will be described in more detail for MPEG2 compression of a video programme. Persons skilled in the art can apply the same principles to other compression schemes. MPEG-1 and MPEG-2 each divides a video input signal, generally a successive occurrence of pictures, into sequences or groups of pictures (“GOP”).

The pictures in respective GOPs are encoded into a specific format. There are generally three different encoding formats which may be applied to video data. Intra-coding produces “I”-pictures, where the encoding relies solely on information within the picture. Inter-coding may produce either a “P” picture or a “B” picture. For a “P picture the encoding relies on a prediction based upon blocks of information found in a prior video frame (either an I-frame or a P-frame, hereinafter together referred to as “reference frame”). For a “B” picture the encoding relies on a prediction based upon blocks of data from at most two surrounding video frames, i.e., a prior reference frame and/or a subsequent reference frame of video data. In principle, in between two reference frames (I-frame or P-frame) several frames can be coded as B-frames. However, since the temporal differences with the reference frames tend to increase if there are many frames in between (and consequently the coding size of a B-frame increases), in practice MPEG coding is used in such a way that in between reference frames only a maximum of two B frames are used, each depending on the same two surrounding reference frames. To eliminate frame-to-frame redundancy, the displacement of moving objects in the video images is estimated for the P-frames and B-frames, and encoded into motion vectors representing such motion from frame to frame.

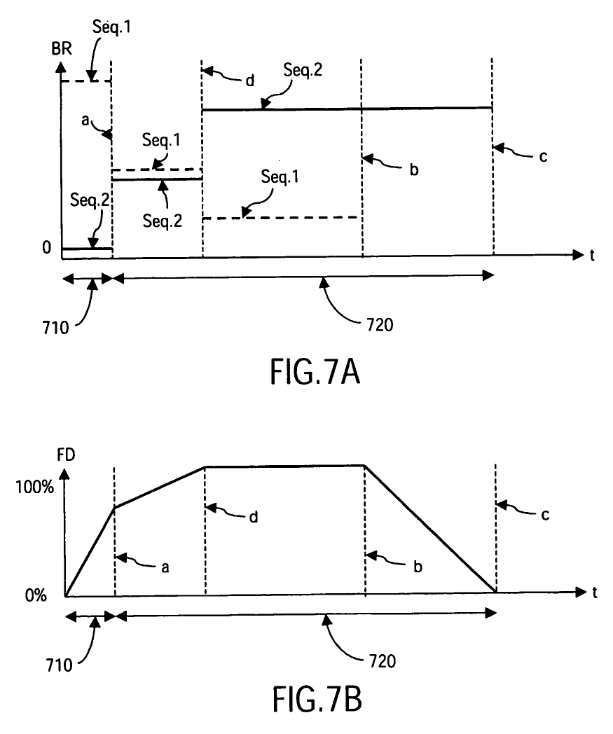

FIG. 5A shows an exemplary sequence of frames according to the MPEG-2 coding and shows the dependencies between the frames using arrows. Caused by the forward dependencies of the B-frames, transmitting the frames in the sequence as shown in FIG. 5A would have the effect that a received B-frame can only be decoded after the subsequent reference frame has been received (and decoded). To avoid having to ‘jump’ through the sequence during the decoding, frames are usually not stored or transmitted in the display sequence of FIG. 5A but in a corresponding transmission sequence as shown in FIG. 5B. In the transmission sequence, reference frames are transmitted before the B-frames that depend on them. This implies that the frames can be decoded in the sequence in which they are received. It will be appreciated that display of a decoded forward reference (P) frame is delayed until the B-frames that depend on it have been displayed. So, in such a compression scheme a few frames are temporarily buffered in decompressed form.

Referring to the MPEG2 encoding scheme as shown in FIG. 5, the decoder usually operates on groups of pictures (GOPs), starting with an I-frame and typically having 15 sequential frames. Without special measures a switch from Seq.2 to Seq.1 (or vice-versa) may result in a worst delay of the rendering time of almost one GOP (roughly 0.5 sec). For example, if the last frame of a GOP of sequence 2 is corrupt, this frame is preferably be replaced by the frame of sequence 1. To be able to provide this frame in decoded form, the entire involved GOP of sequence 1 must be decoded. If decoding is real-time, this takes 15 time intervals, whereas only one time interval is available. As such, a delay of 14 time intervals could occur. In a preferred embodiment according to the invention, the decompressor, such as the decompressor 145 of FIG. 1 or decoder 340 of FIG. 3, is able to decode both sequences in parallel. For the invention it is irrelevant whether parallel is real parallel in the sense of having double hardware/software or is achieved in other ways, such as time-multiplexing. Using a decoder that is capable of real-time decompression (i.e. at the rendering rate) for two streams, the controller ensures that blocks of the first sequence are supplied to the decoder synchronous to supply of corresponding blocks of the second sequence. In this way, always the desired block of the first sequence is also available in decoded form. As an example, if the main buffer according to the invention stores one hundred GOPs (i.e. 1500 frames), where the ‘oldest’ GOP corresponds to the GOP currently being received for sequence 2, then the controller ensures that the decoding of frames of this oldest GOP occurs synchronous to the corresponding frames of sequence 2 currently being received. In this way, sequence 1 is always decoded even if it is not supplied to the output.

The example given above assumes that the received blocks of Seq.1 and Seq.2 are both fully decoded (decompressed). In most systems such full decoding will be used where the resulting output is a digital (or analogue, using a suitable D/A conversion) representation of a programme block, such as a frame, directly used for rendering. It will be understood that in some systems it may be acceptable or desired that the blocks are supplied in an encoded or partially decoded form. For the MPEG2 case, this may mean that if one frame is corrupt in sequence 2, the entire involved GOP is replaced by the corresponding GOP of sequence 1. Thus the representation of a block supplied by the system may be any suitable representation (e.g. ranging from fully decoded in analogue form to fully encoded). Similarly, a block may represent any meaningful unit of data on which the receiving system can switch between the sequences. As described, for MPEG2 video this may, for example, be a frame or a GOP. In general, the controller of the receiving system ensures that the representations of the blocks of the second sequence are generated by supplying the blocks of the second sequence to the decompressor in response to receipt of the block by the receiver. Some small delay may occur in between the actual receipt and supply to the decoder, e.g. to overcome jitter in the transmission. The delivery of the second sequence preferably occurs in one smooth stream from the transmitter to the receiver to the decoder via the output to the rendering/storing function. As such, blocks of the second sequence are delivered to a reception system according to respective time intervals of a predetermined streaming time schedule. For example, using an MPEG2 encoded video with 25 frames per second, a frame is transmitted every 1/25^{th} of a second. For the invention it is irrelevant whether the streaming is done in a pushing manner (the transmitter determines the time schedule) or pulling manner (the rendering device determines the schedule). If the controller detects that a block (e.g. video frame) of the second sequence is not available in the receiving system to be supplied through the output in the time interval that the rendering device needs it, it ensures that the block of the first sequence that corresponds to the missing/corrupt block of the second sequence is supplied to the output. Basically, if the time interval in which a block of the second sequence should have been received has expired and the block has not been received or has been received in a corrupt and unrecoverable form, then the controller directs the corresponding block of the first sequence to the output. It will be appreciated that in the entire path from the transmitter to the rendering device there will normally be some small buffers (e.g. for storing one video frame) in between one or more of the processing functions. So, in the whole chain through the receiving system there may be several frames delay. Thus, the controller can usually know well in advance that a block of the second sequence can not be used and immediately take action to use a corresponding block of the first sequence.

According to the invention, blocks of sequence 1 are transmitted ahead of the corresponding blocks of sequence 2. In particular, if sequence 1 is transmitted on demand the controller causes on-demand downloading of blocks of the first sequence from the transmission system in order to maintain a predetermined filling degree of the buffer. This means that as long as the desired filling degree has not been reached, the controller keeps on requesting download of a new block. The request may be on individual blocks or on groups of blocks. The controller may start the requests as soon as transmission of sequence 2 has started. In such a situation, initially there is no fall-back position. As blocks of sequence 1 arrive faster then blocks of sequence 2, the buffers get filled-up, until the desired filling degree has been reached. The desired filling degree may be ‘full’. Particularly, if groups of blocks are requested the desired filling degree may be such that still an entire group of blocks can be stored. As an alternative to starting the download at the start of sequence 2, the download may be started earlier. In such a case the initial desired filling degree may be less (e.g. only one block) and increased as time goes on until most of the buffer is filled.

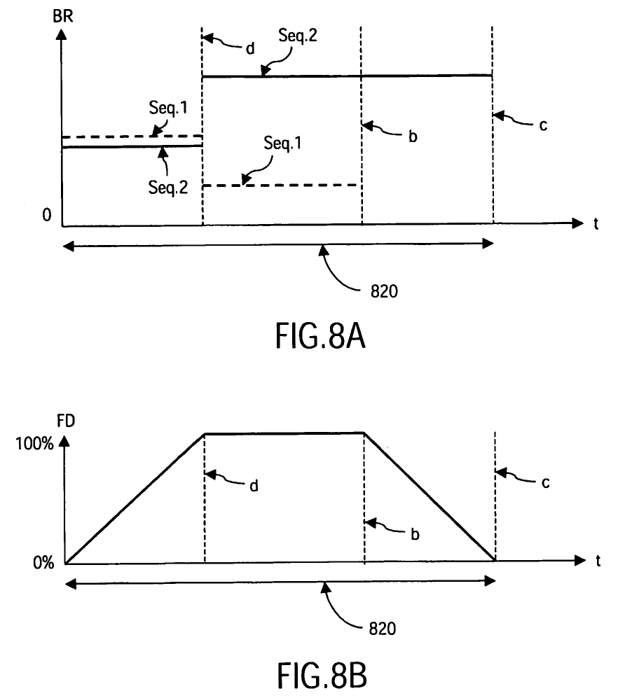

In particular in a system wherein sequence 1 is also transmitted in a streaming form, various forms are possible for filling the buffer. For example, if the buffer can keep one minute of real-time blocks of sequence 1, the transmittal of sequence 1 can be started one minute ahead of sequence 2 at the standard bit-rate for Seq. 1. Alternatively, as long as transmittal of sequence 2 has not yet started, the spare transmission capacity can be used for faster transmission (i.e. faster than real-time rendering rate) of sequence 1. As an example, if sequence 1 is compressed to 25% of the size of sequence 2, then during normal operation there is capacity for transmitting the programme of 1.25 blocks (of sequence 2 size) per time interval. At the start-up when sequence 2 is not yet being transmitted, therefore, a one minute real-time transmission of sequence 1 can be transmitted in 12 seconds. This is illustrated in FIG. 6. During time interval 610 Seq.2 is not transmitted and Seq.1 is transmitted at the full transmission bit-rate (BR) available in the system (typically the bit-rate required for real-time delivery of Seq.2 and Seq.1 in parallel). During interval 620 Seq.2 is transmitted (until time interval c). Since Seq.1 is ahead, transmission of Seq.1 also terminates earlier, indicated by time instance b. FIG. 6B shows the filling degree (FD) of the buffer during this schedule.

FIG. 7 shows an alternative. During the start-up interval 710, Seq.1 is transmitted at full transmission bit-rate to achieve an initial filling quickly. To reduce this time interval, the buffer is not fully filled. Instead at instance a, transmission of Seq.2 starts. To be able to fill the buffer further until the maximum, during the period until the buffer is full (instance d) Seq.2 is transmitted at a reduced transmission bit-rate (since the transmission of Seq.2 is real-time this implies a higher compression). In the example, the total available transmission bit rate is divided almost equally between the sequences. The quality (compression ratio) of Seq.1 is kept the same, thus more blocks of Seq.1 can be transmitted than real-time would be the case at the standard transmission bit-rate for Seq. 1. As can be seen in FIG. 7B, in this way the buffer is filled further. Once the buffer is full, Seq.1 is transmitted at the default quality coding and corresponding transmission bit-rate..

FIG. 8 shows a further alternative. In this example, there is no start up phase like interval 610 and 710. Instead transmittal of Seq.1 and Seq.2 starts simultaneously. By reserving a larger transmission capacity then required (e.g. 1.3 times a sequence 2 block per time interval), this extra capacity can be used to transmit additional blocks of sequence 1 until the buffer is full. FIG. 8 shows an alternatively, where the total transmission capacity is not increased, but instead until time interval d Seq.2 is transmitted at a higher compression. This gives additional transmission bandwidth for Seq.1. By not increasing the quality of compression of Seq.1, the additional transmission capacity is used to transmit the blocks of Seq.1 quicker than real-time, filling up the buffer. When the buffer is full at instant d, the system is the same as described above.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A delivery system (100) for streamed delivery of a programme including a sequence of content parts; the system including:
a compression system (110) for compressing the programme into a first sequence of blocks and into a second sequence of blocks; a correspondence between blocks of the first and second sequence being established by blocks in the first sequence and the second sequence that relate a same content part in the programme being identifiable;
a transmission system (120) for delivery of blocks of the second sequence to a reception system according to respective time intervals of a predetermined real-time delivery schedule and for delivery of the first sequence of blocks to the reception system, where blocks of the first sequence are being transmitted earlier than corresponding blocks of the second sequence; and
a reception system (130) including:
a receiver (135) for streamed reception of the second sequence of blocks and for reception of the first sequence of blocks;
a buffer (140) for temporarily storing blocks of the first sequence of blocks that correspond to blocks of the second sequence for which the delivery schedule has not yet expired;
an output (155) for supplying content parts of the programme; and
a controller (160) operative to direct to the output for each time interval of the delivery schedule:
a representation of a block of the second sequence if such a block was received successfully for the time interval, or
a representation of a corresponding block stored in the buffer if the block of the second sequence was not received successfully for the time interval.

2. A system as claimed in claim 1, wherein the first sequence of blocks has a first bit-rate and the second sequence of blocks has a second bit-rate that is higher than the first bit-rate.

3. A system as claimed in claim 1, wherein the first and second sequence of blocks are transmitted in distinct transmission channels.

4. A system as claimed in claim 1, wherein the first sequence of blocks is delivered using streamed delivery.

5. A system as claimed in claim 4, wherein the first and second sequence of blocks are multiplexed in a same streaming channel.

6. A system as claimed in claim 1, wherein the second sequence of blocks is broadcast.

7. A system as claimed in claim 1, wherein the controller is operative to cause on-demand downloading of blocks of the first sequence from the transmission system in order to maintain a predetermined filling degree of the buffer.

8. A system as claimed in claim 1, wherein the delivery system is operative to fill the buffer to a predetermined filling degree before starting the streamed transmission of the second sequence of blocks.

9. A system as claimed in claim 1, wherein the reception system includes a decompressor for decompressing blocks of the first and second sequence of blocks; the controller being operative to cause decompression of a block of the second sequence substantially in response to receipt of the block, and to cause decompression of a block of the first sequence substantially synchronous to decompression of a corresponding block of the second sequence..

10. A system as claimed in claim 1, wherein the bit-rate of the first sequence is less than 25% of the bit-rate of the second sequence.

11. A transmission system for streamed delivery of a programme including a sequence of content parts; the system including:
a compression system for compressing the programme into a first sequence of blocks and into a second sequence of blocks; a correspondence between blocks of the first and second sequence being established by blocks in the first sequence and the second sequence that relate a same content part in the programme being identifiable; and
a transmitter for delivery of blocks of the second sequence to a reception system according to respective time intervals of a predetermined real-time delivery schedule and for delivery of the first sequence of blocks to the reception system, where blocks of the first sequence are being transmitted earlier than corresponding blocks of the second sequence.

12. A reception system including a receiver for reception of a first sequence of blocks and for streamed reception of a second sequence of blocks, where the first sequence of blocks includes a compressed form of a programme and the second sequence of block includes compressed form of the same programme; a correspondence between blocks of the first and second sequence being established by blocks in the first sequence and the second sequence that relate a same content part in the programme being identifiable; blocks of the second sequence being transmitted according to respective time intervals of a predetermined real-time delivery schedule; blocks of the first sequence being transmitted earlier than corresponding blocks of the second sequence;
a buffer for temporarily storing blocks of the first sequence of blocks that correspond to blocks of the second sequence for which the delivery schedule has not yet expired;
an output for supplying content parts of the programme; and
a controller operative to direct to the output for each time interval of the delivery schedule:
a representation of a block of the second sequence if such a block was received successfully for the time interval, and
a representation of a corresponding block stored in the buffer if the block of the second sequence was not received successfully for the time interval.

13. A method of streamed receipt of a programme including a sequence of content parts; the method including:
receiving a first sequence of blocks and receiving a second sequence of blocks in a streamed manner, where the first sequence of blocks includes a compressed form of a programme and the second sequence of block includes compressed form of the same programme; a correspondence between blocks of the first and second sequence being established by blocks in the first sequence and the second sequence that relate a same content part in the programme being identifiable; blocks of the second sequence being transmitted according to respective time intervals of a predetermined realtime delivery schedule; blocks of the first sequence being transmitted earlier than corresponding blocks of the second sequence;
temporarily storing blocks of the first sequence of blocks that correspond to blocks of the second sequence for which the streaming time schedule has not yet expired;
supplying content parts of the programme for each time interval of the delivery schedule by providing a representation of a block of the second sequence if such a block was received successfully for the time interval, or a representation of a corresponding stored block of the first sequence if the block of the second sequence was not received successfully for the time interval.

14. A computer programme products operative to cause a processor to perform the method as claimed in claim 13.
